(19) United States
(12) Patent Application Publication
(10) Pub. No.: US 2010/0141658 A1
(43) Pub. Date: Jun. 10, 2010

(54) TWO-DIMENSIONAL SHADOWS SHOWING THREE-DIMENSIONAL DEPTH

(75) Inventors: Stephen M. Danton, Seattle, WA (US); Randy S. Kimmerly, Woodinville, WA (US); Christopher Lee Anderson, Redmond, WA (US); E. James Gale, Duvall, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/331,245

(22) Filed: Dec. 9, 2008

(51) Int. Cl. G06T 11/20

(52) U.S. Cl. 345/441

(57) ABSTRACT

Digital shadowing when rendering visual items (e.g., windows) at different virtual display levels (such as z-order levels). The rendering is based on the determination of a position and virtual display level for each of the visual items to be displayed. For those visual items that cast a shadow on lower-level in-shadow visual items, the determined position of the shadow-casting visual item is used to render the shadow on each of the in-shadow visual items differently depending on the corresponding virtual display level of the in-shadow visual items. In particular, the in-shadow visual item that has a lower virtual display level has a longer shadow cast by the shadow-casting visual item than those in-shadow visual items that have a higher virtual display level. This allows the shadows to have a more natural look.

### BACKGROUND

Often, the most effective way to convey information to a human being is visually. Accordingly, computing systems that interface with a user almost inevitably have a display that displays various items at the direction of software and/or hardware. For instance, computing systems often display one or more windows or other visual elements that appear to be positioned in several layers. For instance, there might be a background, a window appearing above the background, another window appearing above that window, and so forth. The various levels at which a visual element may appear is identified by a z-order. For instance, a z-order of 1 is the first level just above the background, a z-order of 2 is the next level just above the z-order: 1 window, and so forth.

Of course, the display is just two-dimensional. However, the illusion of one visual element being above the other allows the user to feel that they are working with a real work surface in which some objects are placed above others. One of the effects that creates this illusion is that when a visual element of a higher z-order overlaps a visual element of a lower z-order, the higher z-order visual element tends to obscure the lower z-order element. If the higher z-order visual element is completely opaque, the lower z-order element will not be visible at all in the area of the overlap, thus creating an illusion that one visual element is above the other.

In order to enhance the illusion of three-dimensions, visual elements are often also given shadows. For instance, if the periphery just outside and along the lower and right edges of the visual element is shaded somewhat, it gives the appearance that a virtual light source in front of and angled slightly from the upper-left of the display is shining on the visual element, causing a shadow to form below the visual element. This shadowing further enhances the observer's perception that he/she is looking at a three-dimensional work area.

However, in conventional shadowing, the offset of the shadow with respect to the visual item is usually fixed. That is to say, a shadow might extend “m” pixels in a vertical direction (e.g., below the visual element), and “n” pixels in a horizontal direction (e.g., to the right of the visual element), where m and n are fixed integers, regardless of what is in the shadow of the visual element. Once the shadow is formed, the shadow moves with the visual element, enhancing the illusion that it is a literal shadow. The form of the shadow does not tend to change as different items move into and out of the shadow of the moving visual element.

### BRIEF SUMMARY

Embodiments described herein relate to the formulation of shadowing when rendering visual items at different virtual display levels. The rendering is based on the determination of a position and virtual display level for each of the visual items to be displayed. For those visual items that cast a shadow on lower-level in-shadow visual items, the determined position of the shadow-casting visual item is used to render the shadow on each of the in-shadow visual items differently depending on the corresponding virtual display level of the in-shadow visual items. In particular, the in-shadow visual item that has a lower virtual display level has a longer shadow cast by the shadow-casting visual item than those in-shadow visual items that have a higher virtual display level. This allows the shadows to have a more natural look, and supports the illusion that the virtual levels of the two-dimensional display are actually physical levels in a three-dimensional display.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system that represents an environment in which the principles described herein may be implemented;

FIG. 2 illustrates a flowchart of a method for displaying visual items;

FIG. 3 illustrates a flowchart of a method for displaying shadowed visual items in a multiple virtual display level environment;

FIG. 4A illustrates an example of four visual items to be displayed at four different virtual display levels;

FIG. 4B illustrates an example of the four visual items of FIG. 4A positioned in an appropriate example position;

FIG. 5A illustrates an aggregated rendering of the visual items in a first stage of rendering in which only the shadows are illustrated as cast on the background canvas by the upper visual items of FIG. 4B;

FIG. 5B illustrates the aggregated rendering of FIG. 5A, except now with the first virtual display level visual item overlaid in the rendering;

FIG. 5C illustrates the aggregated rendering of FIG. 5B, except now with shadows cast by the upper visual items of FIG. 4B cast upon the first virtual display layer visual item;

FIG. 5D illustrates the aggregated rendering of FIG. 5C, except now with the second virtual display level visual item overlaid in the rendering;

FIG. 5E illustrates the aggregated rendering of FIG. 5D, except now with shadows cast by upper visual items of FIG. 4B cast upon the second virtual display layer visual item;

FIG. 5F illustrates the aggregated rendering of FIG. 5E, except now with the third virtual display level visual item overlaid in the rendering;

FIG. 5G illustrates the aggregated rendering of FIG. 5F, except now with shadows cast by the fourth virtual display level visual item of FIG. 4B cast upon the third virtual display layer visual item;

FIG. 5H illustrates the aggregated rendering of FIG. 5G, except now with the fourth virtual display level visual item overlaid in the rendering;

FIG. 6A illustrates the layered aggregation of FIG. 4B, except now with the fourth virtual display level visual item moved to the right, and with its shadows adjusted accordingly; and

FIG. 6B illustrates the layered aggregation of FIG. 6A, except now with the fourth virtual display level visual item moved even further to the right, and with its shadows adjusted accordingly.

### DETAILED DESCRIPTION

Embodiments described herein relate to the formulation of digital shadowing when rendering visual items (e.g., windows) at different virtual display levels (e.g., z-order display levels). The rendering is based on the determination of a position and virtual display level for each of the visual items to be displayed. For those visual items that cast a shadow on lower-level in-shadow visual items, the determined position of the shadow-casting visual item is used to render the shadow on each of the in-shadow visual items differently depending on the corresponding virtual display level of the in-shadow visual items. In particular, the in-shadow visual item that has a lower virtual display level has a longer shadow cast by the shadow-casting visual item than those in-shadow visual items that have a higher virtual display level. This allows the shadows to have a more natural look, and is perceived by a human viewer as supporting the illusion that the virtual levels of the two-dimensional display are actually physical levels in a three-dimensional display.

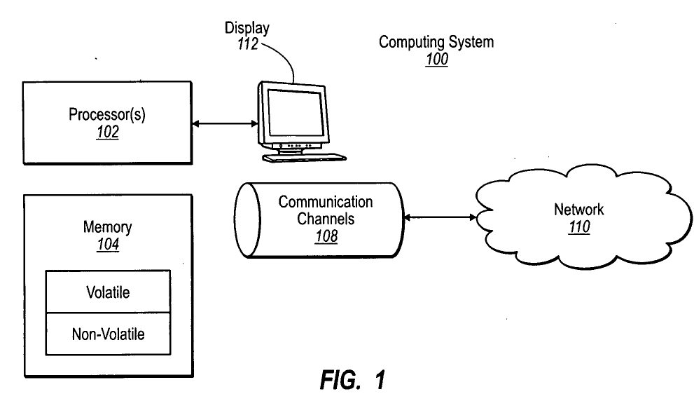

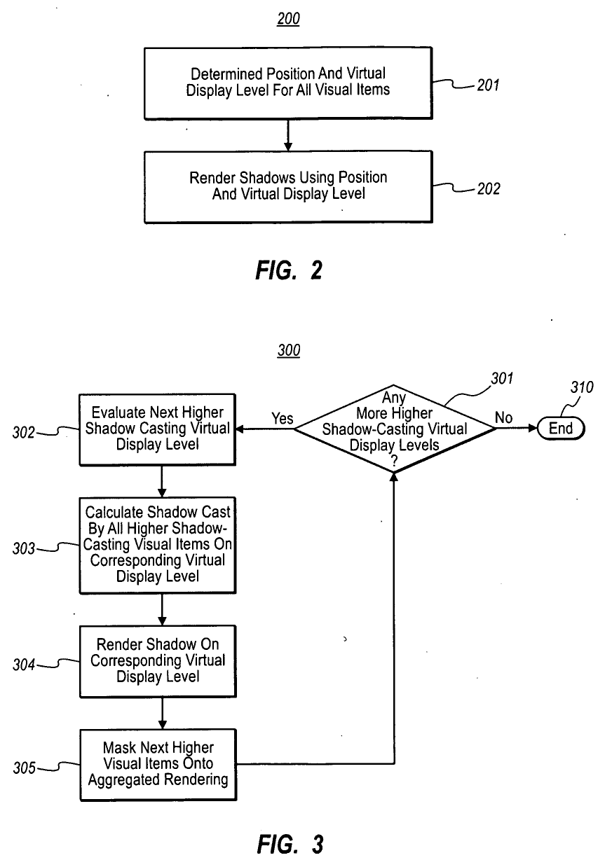

First, some introductory discussion regarding a computing system in which the principles described herein may be employed will be described with respect to FIG. 1. Then, various embodiments of the use of digital shadow generation will be described with respect to FIGS. 2 through 6B.

FIG. 1 illustrates a computing system 100. Computing systems are now increasingly taking a wide variety of forms. Computing systems may, for example, be handheld devices, appliances, laptop computers, desktop computers, mainframes, distributed computing systems, or even devices that have not conventionally considered a computing system. In this description and in the claims, the term “computing system” is defined broadly as including any device or system (or combination thereof) that includes at least one processor, and a memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memor” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100.

Computing system 100 may also contain communication channels 108 that allow the computing system 100 to communicate with other message processors over, for example, network 110. A display 112 may also be provided for displaying an application work interface to the user. Communication channels 108 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

FIG. 2 illustrates a flowchart of a method 200 for displaying shadows for a variety of visual items displayed at various virtual display levels. The display may be two-dimensional, but the virtual display levels are designed to given the impression that there are various layers of visual items, some displayed on top of the other. The shadowing gives the illusion that the two-dimensional display is actually three-dimensional. The principles described herein allow the shadowing to appear quite realistic, appearing more like there is an actual light source that is emitting light that is incident on visual items. For instance, if there are multiple levels of items in the shadow of a particular visual item, the shadow cast by that visual item will be longer the greater if the number of virtual levels between the shadow-casting visual item and the in-shadow visual item is greater.

The method 200 may be performed in hardware and/or via software. For instance, in the case of software, a physical computer program product may include one or more computer-readable media having thereon one or more computer-executable instructions that, when executed by one or more processors of a computing system, causes the computing system to perform the method 200. For instance, referring to FIG. 1, the processing unit 102 of FIG. 1 may execute computer-executable instructions on a physical computer program product, causing the computing system 100 to render visual items on the display 112.

The position and virtual display level is determined for each of the visual items to be displayed on the display (act 201). In one embodiment, the virtual display level may be, for example, a z-order layer. For instance, a z-order:0 layer may be a background canvas. A z-order:1 layer may be a layer of visual item(s) (such as perhaps a window) that virtually resides above the background canvas. A z-order:2 layer may be a layer of visual item(s) that virtually resides above the z-order:1 layer. If a visual item (such as a window or other visual gadget) of a higher z-order is moved to occupy the same space as a lesser z-order visual item, the higher z-order visual item is made to appear as though it moves over the lesser z-order visual item, giving the appearance of a three-dimensional workspace. To further the illusion, higher z-order visual items cast shadows on lower z-order visual items. That said, the principles described herein are not limited to virtual display levels that are composed of z-order levels.

There may be as little as one visual item to be displayed, and as many as countless visual items to be displayed. However, in order for one visual item to cast a shadow on another visual item, there should be more than one visual item to be displayed, and at different virtual display levels. Furthermore, if a shadow-casting visual item is to cast a shadow on visual items across multiple display levels, there would be at least three virtual display levels. That said, the principles described herein may be applied to an environment in which there are any number of virtual display levels.

The visual items may be any visual item. An example of such a visual item is a window. Other examples might include a clock or other visual gadget. The visual item need not be rectangular, but may be any form. The visual item may be opaque as in traditional windowing technology, but might also be partially translucent. In the cast of a partially translucent visual item, the shadow cast by a partially translucent portion will be somewhat weaker than the shadow cast by an opaque portion of a visual item. Thus, the level of translucency of the visual item may be taken into consideration when calculating the degree to which the underlying in-shadow visual item(s) are darkened. If the visual item is translucent, there is no requirement that the entire visual item be translucent, nor that the translucent portion of the visual item has a uniform degree of translucency.

Regardless of the number of visual items to be rendered, and regardless of the number of visual display levels, the position and virtual display level is determined for all of the visual items (act 201). Then, for at least one, possible some, and perhaps even for all of the visual items to be displayed (except for perhaps the background) a shadow is rendered for the visual item. A visual item that is to have an associated shadow rendered will be referred to in this description and in the claims as a “shadow-casting” visual item. On the other hand, a visual item that is within the shadow of another visual item will be referred to in this description and in the claims as an “in-shadow” visual item. That said, a visual item may be both a shadow-casting visual item and an in-shadow visual item if it is at least partially within the shadow of another visual item, and also casts its own shadow.

For the shadow casting visual items, the position of the shadow-casting visual item and the corresponding virtual display level is used in order to render the shadow (act 202). In this description and in the claims, “rendering” a shadow does not necessarily mean that the shadow is yet displayed, but does mean that the shadow is calculated at least in virtual space before the shadow is displayed. The shadow is rendered in each of the in-shadow visual items different depending on the corresponding virtual display level of each of the in-shadow visual items. For instance, in-shadow visual items having a lower virtual display level has a longer shadow cast by the shadow-casting visual item. On the other hand, in-shadow visual items having a higher virtual display level has a shorter shadow cast by the shadow-casting visual item.

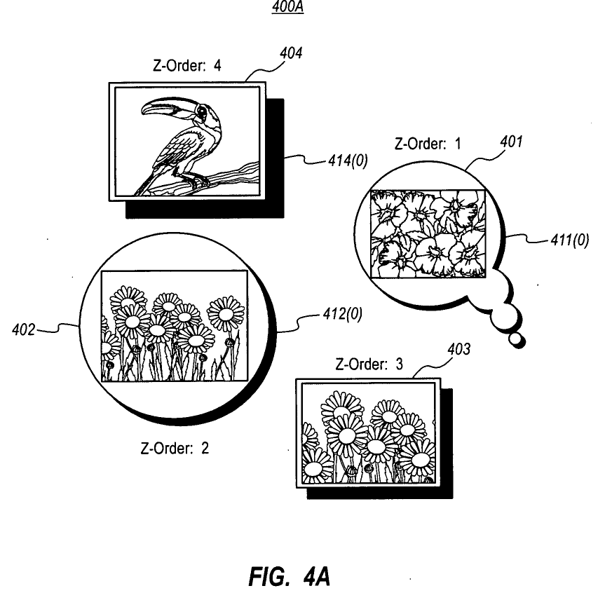

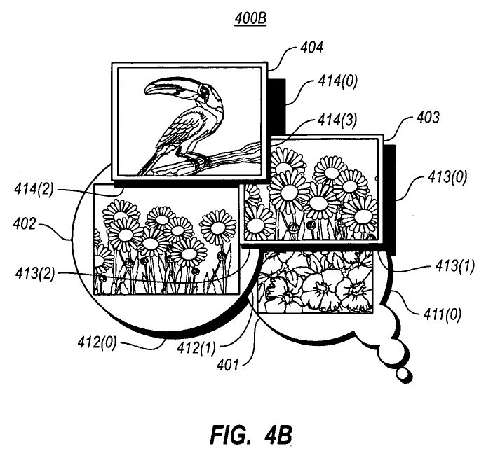

Any mechanism for rendering such shadows is within the scope of the principles described herein. Nevertheless, as a specific example, FIG. 3 illustrates a flowchart of a method 300 for rendering in a visual environment that includes a background that has the lowest virtual display level, and a number of higher shadow-casting virtual display levels. For instance, FIG. 4A illustrates four visual items 401 through 404 at four different virtual display levels.

In order to give a sense for the visual display level, the visual items 401 through 404 are each illustrated with a corresponding shadow as the shadow would be cast upon a background canvas. For instance, the first level visual item 401 (having a z-order of 1) is shown along with its corresponding shadow 411(0) that is cast upon the background canvas. The second level visual item 402 (having a z-order of 2) is shown along with its corresponding shadow 412(0) that is cast upon the background canvas. The third and fourth visual items 403 and 404 (having z-orders of 3 and 4, respectively) also are shown as casting corresponding shadows 413(0) and 414(0), respectively, on the background canvas. Note how the second level visual item 402 casts a longer shadow upon the background canvas than does the lower first level as visual item 401. Likewise, the third level visual item 403 casts a longer shadow upon the background canvas than does the lower first and second level visual items 401 and 402. Finally, the fourth level visual item 404 casts an even longer shadow upon the background canvas than does the lower three visual items 401, 402 and 403. This gives the illusion that the visual items 401 through 404 are actually layered in order of ascending elevation above the background canvas.

Naturally, if there were more virtual display levels, even longer shadows might be cast. Furthermore, even though the virtual display levels are illustrated as being approximately evenly distributed, the virtual display levels may have other virtual distances separating them as well. For instance, if the second virtual display level was to be twice the virtual distance from the background canvas as the first virtual display levels, the second level visual items may be made to cast shadows that are twice as long as the shadows cast by the first level visual items. However, if the second virtual display level was only half the virtual distance to the first virtual display level as the first virtual display level was from the background canvas, the shadow cast by the second level visual item might only be fifty percent longer as cast on the background canvas as the shadow cast by the first level visual item.

Also, in FIG. 4A, the shadows are cast in a manner to emulate that there is a virtual light source shining onto the display from the upper left corner. However, the principles described herein are not so limited. Rather, the shadows could be calculated based on any virtual light position. Furthermore, the shadows in FIG. 4A are rather crisp, suggesting a point light source. However, the shadows may also be calculated based on an area light source, thereby causing the shadow to have a more gradual edge.

In addition, if the virtual light source were infinitely distant, the shadow may be made to have the same size as the visual item casting the shadow as is the cast with FIG. 4A. However, if the light source were closer, the shadow cast may be somewhat larger than the visual item that casts the shadow. Furthermore, in that case, the direction that the shadow is cast may be different depending on the lateral position of the virtual item. For example, if the virtual light source were positioned close to the display and in the center, visual items would tend to cast shadows radially away from the center of the display.

There may be even multiple discrete lights sources thereby causing multiple corresponding shadows to be cast by each visual item. As an example, the visual item being displayed might itself be a virtual light source used as a mechanism to highlight that visual item. The highlighted visual item may cause lower level visual items to cast additional shadows, and may optionally reflect light off of higher level visual items. The highlighted visual item might be a virtual area light source. A visual item might also be highlighted by changing a level of transparency of the visual item. For instance, a highlighted visual item might be made completely opaque whereas it has some transparency when not highlighted.

Furthermore, the color of the shadow need not be grey, but may be some other configurable color, such as blue, red, orange, green, purple, and so forth. The color of the shadow, the position and nature of the virtual light sources, and so forth, may be configured by the user, and/or may be a default setting. The color and intensity of the shadow might be a function of the transparency and filtering to be simulated by the shadow-casting visual item, and be a function of the material characteristics of the in-shadow visual item. For instance, suppose that a visual item casts a red shadow. In other words, the visual item is transparent to red light, but not to other light. Now suppose that the in-shadow visual item is actually blue. The in-shadow visual item would absorb all of the red light causing the shadowed area upon the in-shadow visual item to be black. Thus, the shadow color may be a function of not only what light is permitted to pass through the shadow-casting visual item, but may also be a function of the simulated material of the in-shadow visual item.

The shadow casting visual item will thus generate a shadow that is a function of the visual characteristics of the shadow casting visual item. Stated more broadly, the shadow casting visual item may perform some visual transformation of the virtual light that is incident on the shadow-casting visual item. A simple example of a visual transformation is complete attenuation of light (i.e., the shadow-casting visual item is completely opaque). Another visual transformation is partial attenuation of light (i.e., the shadow-casting visual item is partially opaque). This partial attenuation might vary across the area of the visual item, causing an appearance of non-uniform transparency. Alternatively or in addition, the attenuation may differ depending on the wavelength of light. For instance, a green visual item might reflect all or some green wavelengths, while allowing other wavelengths to pass with less or no attenuation.

As another example, the direction of light may change as it passes through the visual item. If the directional change is uniform across the entire area of the shadow-casting visual item, the in-shadow visual item, as perceived through the partially transparent shadow-casting visual item, will appear clear, but refracted. If the directional change is not uniform across the area of the shadow-casting visual item, this will make the shadow-casting visual item to appear textured, in addition to partially transparent. Of course, in any of these visual transformations, light is not actually being filtered per se, but the characteristics of the filtration are calculated and displayed on the display as though the filtration actually occurred. This further encourages the viewer to suspend disbelief and operate under the illusion that the two-dimensional display is actually a three-dimensional working surface.

FIG. 4B illustrates the visual environment 400B in which each of the visual elements is positioned in an aggregated rendering. Here, not only are the shadows illustrated as cast upon the background canvas, but shorter shadows are illustrated as cast upon other intermediary in-shadow visual items. For instance, visual item 402 casts a shadow 412(0) upon the background canvas, but also casts a shorter shadow 412(1) on the first level visual item. Likewise, the third level visual item 403 casts a show 413(0) upon the background canvas, but also casts a shorter shadow 413(1) on the first layer visual item 401, and an even shorter shadow 413(2) on the second layer visual item 402. Finally, the fourth level visual item 404 casts a shadow 414(0) upon the background canvas, but also casts a shorter shadow 414(2) on the second level visual item 402, and an even shorter shadow 414(3) on the third level visual item 403. The effect of having a single shadow-casting virtual item casting different lengths of shadows on different visual items in this manner reinforces the three-dimensional layering illusion.

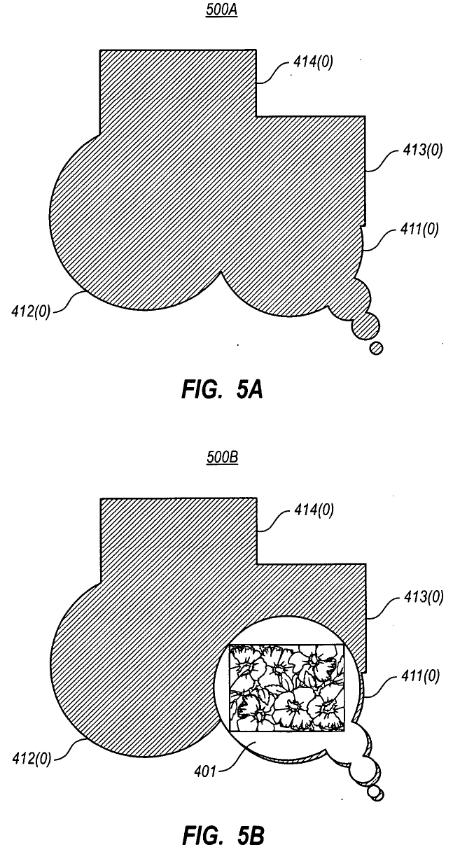

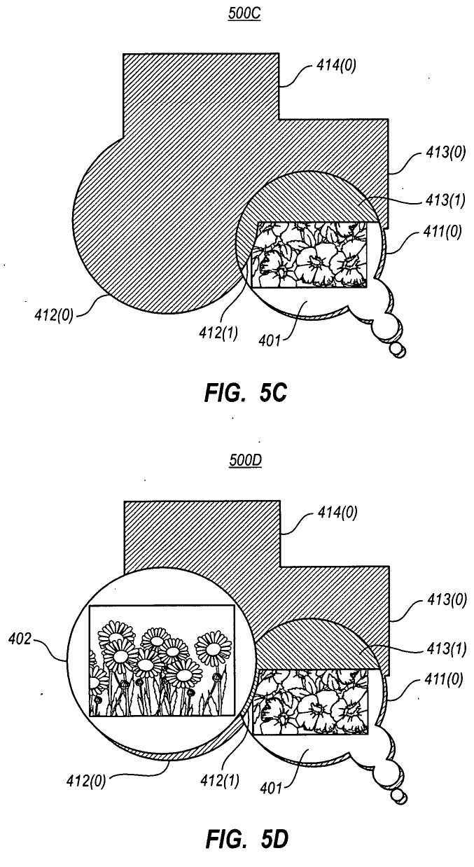

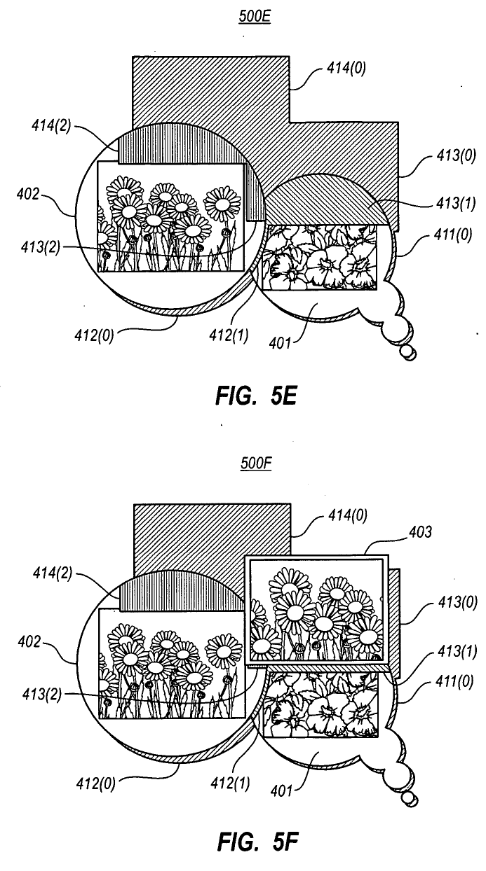

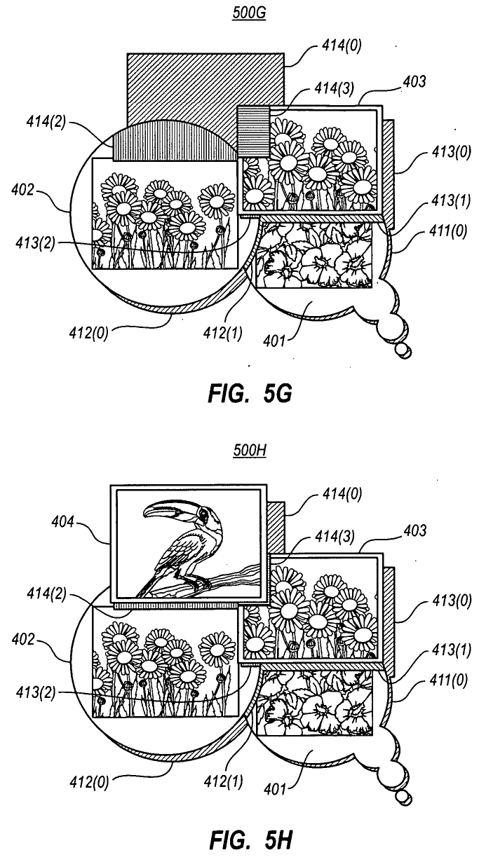

FIG. 5A through 5H illustrate consecutive phases of construction when formulating an aggregated rendering of visual items such as that shown in FIG. 4B. FIGS. 5A through 5H may be encountered when performing the method 300 of FIG. 3 in order to construct the aggregated rendering of FIG. 4B. Accordingly, FIGS. 5A through 5H will now be described with frequent reference to FIG. 3.

The method 300 is performed iteratively, once for each visual display level beginning at the background level (e.g., the background canvas) and then continuing for ever increasing virtual display levels. Accordingly, the method 300 begins with a decision block 301 that determines whether there or not there are more virtual display levels to be evaluated (decision block 301). If there are not more display levels (No in decision block 301), the method ends (act 310). However, for now, the construction of the aggregated rendering has only just begun. Accordingly, the method proceeds (Yes in decision block 301) to the act 302, where the next virtual display level is evaluated (act 302). In this case, the method first proceeds to the zero level visual item, which is the background canvas.

Specifically, the method 300 calculates a shadow that would be cast on any visual display items of the corresponding virtual display level by collectively all of the shadow-casting visual items that are at higher virtual display levels than the corresponding virtual display level (act 303). This calculation considers a difference in the virtual display level of the shadow-casting visual item and the corresponding display level that the shadow is cast on. FIG. 5A is the resulting initial aggregated rendering 500A resulting from the rendering of the shadows (act 304). Here, the corresponding virtual display level is the background canvas, and the higher level visual items are the visual items 401 through 404. There are simply four overlapping shadows 411(0), 412(0), 413(0) and 414(0) that would be caused by respective visual items 401, 402, 403 and 404 as illustrated in FIG. 5A. For now, however, in the case of FIG. 5A, the visual items 401, 402, 403 and 404 are not included in the aggregated rendering.

Next, as shown in FIG. 5B, the visual item(s) from the next higher virtual display level (in this case, the first visual item 401 of the first virtual display level) is masked on top of the aggregated rendering (act 305), resulting in aggregated rendering 500B. Here, since the position of the first visual item 401 was already known, and indeed was used to determine the position of its shadow 411(0) in the first place, the first visual item 401 is simply placed in its proper position in the rendering. The method returns to the decision block 301, where it is determined that there are more virtual display levels that include a shadow-casting visual item (Yes in decision block 301). The method then evaluates the next higher virtual display level (act 302), or in this case, the first virtual display level.

The method 300 calculates a shadow that would be cast on any visual display items of the corresponding virtual display level (i.e., in this case, the first visual item of the first display level) by collectively all of the shadow-casting visual items that are at higher virtual display levels than the corresponding virtual display level (act 303) (in this case, the visual items 402, 403 and 404 of the higher virtual display levels). Once again, this calculation considers the difference in the virtual display level of the shadow-casting visual item and the first display level that the shadow is cast upon. FIG. 5C is the resulting aggregated rendering 500C after rendering the shadows (act 304). Here, the corresponding virtual display level is the first virtual display level, and the higher level visual items are the visual items 402 through 404. There are only two overlapping shadows 412(1) and 413(1) that would be caused by respective visual items 402 and 403 as illustrated in FIG. 5C. For now, however, in the case of FIG. 5C, the visual items 402, 403 and 404 are not included in the aggregated rendering.

Next, as shown in FIG. 5D, the visual item(s) from the next higher virtual display level (in this case, the second visual item 402 of the second virtual display level) is masked on top of the aggregated rendering (act 305) resulting in aggregated rendering 500D. Here, the second visual item 402 is positioned at the position previously determined, for example, in act 201 of method 200. Note how the shadow 412(1) cast by the second visual item 402 on the first level visual item 401 is shorter than the shadow 412(0) cast by the second visual item 402 on the background canvas. The method returns to the decision block 301, where it is determined that there are more virtual display levels that include a shadow-casting visual item (Yes in decision block 301). The method then evaluates the next higher virtual display level (act 302), or in this case, the third virtual display level.

The method 300 calculates a shadow that would be cast on any visual display items of the corresponding virtual display level (i.e., in this case, the second visual item of the first display level) by collectively all of the shadow-casting visual items that are at higher virtual display levels than the corresponding virtual display level (act 303) (in this case, the visual items 403 and 404 of the higher virtual display levels). Once again, this calculation considers the difference in the virtual display level of the shadow-casting visual item and the first display level that the shadow is cast upon. FIG. 5E is the resulting aggregated rendering 500E after having rendered the shadows (act 304). Here, the corresponding virtual display level is the second virtual display level, and the higher level visual items are the visual items 403 and 404. There are two overlapping shadows 413(2) and 414(2) that would be caused by respective visual items 403 and 404 as illustrated in FIG. 5E. For now, however, in the case of FIG. 5E, the visual items 403 and 404 are not included in the aggregated rendering.

Next, as shown in FIG. 5F, the visual item(s) from the next higher virtual display level (in this case, the third visual item 403 of the third virtual display level) is masked on top of the aggregated rendering (act 305) resulting in aggregated rendering 500F. Here, the third visual item 403 is positioned at the position previously determined, for example, in act 201 of method 200. Note how the shadow 413(2) cast by the third visual item 403 on the second level visual item 402 is shorter than the shadow 412(1) cast by the third visual item 403 on the first level visual item 401, which is shorter than the shadow 413(0) cast by the third visual item 403 on the background canvas. The method returns to the decision block 301, where it is determined that there are more virtual display levels that include a shadow-casting visual item (Yes in decision block 301). The method then evaluates the next higher virtual display level (act 302), or in this case, the fourth virtual display level.

The method 300 calculates a shadow that would be cast on any visual display items of the corresponding virtual display level (i.e., in this case, the third visual item of the first display level) by collectively all of the shadow-casting visual items that are at higher virtual display levels than the corresponding virtual display level (act 303) (in this case, the visual item 404 of the fourth virtual display levels). Once again, this calculation considers the difference in the virtual display level of the shadow-casting visual item and the various display levels that the shadow is cast upon. FIG. 5G is the resulting aggregated rendering 500G after rendering the shadows (act 304). Here, the corresponding virtual display level is the third virtual display level, and the higher level visual item is the visual item 404. There is but one shadow 414(3) that would be caused by the visual item 404 as illustrated in FIG. 5G.

Next, as shown in FIG. 5H, the visual item(s) from the next higher virtual display level (in this case, the fourth visual item 404 of the fourth virtual display level) is masked on top of the aggregated rendering (act 305) resulting in aggregated rendering 500H. Here, the fourth visual item 404 is positioned at the position previously determined, for example, in act 201 of method 200. Note how the shadow 413(3) cast by the fourth visual item 403 on the third level visual item 403 as is much shorter than the shadow 414(0) cast by the fourth visual item 404 on the background canvas. The method returns to the decision block 301, where it is determined that there are no more virtual display levels that include a shadow-casting visual item (No in decision block 301). Accordingly, the method 300 ends.

A single aggregated rendering may be performed for a single static position of the visual items. However, multiple formulations of iterative aggregated renderings may be performed in order to make the visual items more dynamic. Performing the method 300 for multiple iterative positions of the visual items will cause the shadows also to be updated such that longer shadows are cast upon the lower virtual display levels, and shorter shadows are cast upon higher virtual display levels. There may actually be a number of events that cause the shadows to be re-rendered using the method 300 of FIG. 3. As an example, one or more of the visual items may be moved translationally and/or rotationally. Alternatively or in addition, one or more of the visual items may be resized, deleted, or added. Additionally, perhaps the visual characteristics of one or more visual items have changed. For instance, perhaps one of the visual items becomes a virtual light source, stops being a light source, or has a light source intensity that changed. Perhaps the visual item is caused to change color, texture, transparency level or some other visual feature. Perhaps a virtual light source is moved, or its intensity changed. Any change that might cause a change in how the shadow is cast may cause a re-rendering of the shadows.

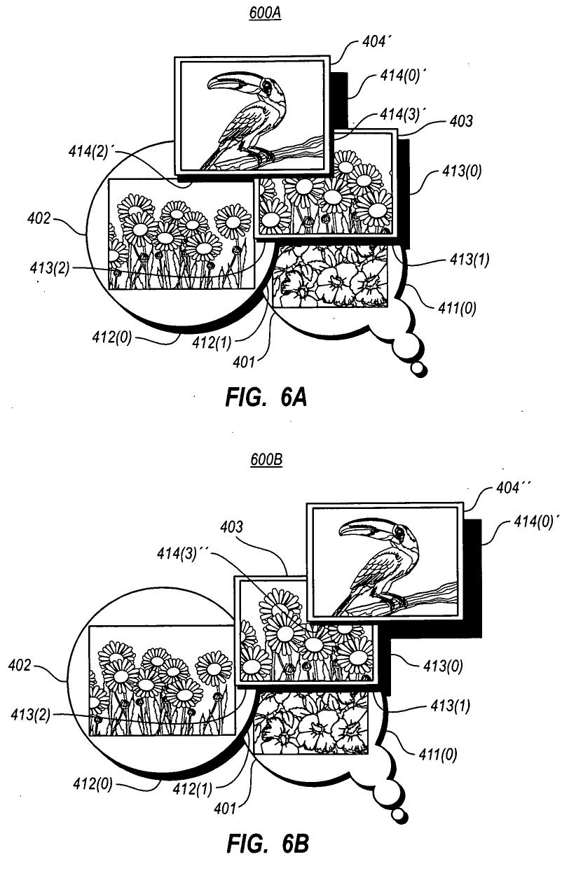

FIGS. 6A and 6B illustrate one example in which a visual item is translationally moved. For instance, FIG. 6A shows a progression 600A from FIG. 4B in which the visual item 401 is moved to the right resulting in visual item 401′, and resulting in modified shadows 414(0)′, 414(2)′ and 414(3)′. FIG. 6B shows a further progression 600B from FIG. 6A in which the visual item 401′ is moved even further to the right resulting in visual item 401″, and modified shadows 414(0)″, and 414(3)″. The shadow 414(2) has disappeared entirely. By making these updates often while moving a visual item, the illusion of a three-dimensional layered interface is further enhanced.

In one embodiment, the position and/or nature of the virtual light source may change. For instance, the user might drag a virtual light source around the screen and adjust the distance of the virtual light source from the display, thereby causing the shadows to be updated accordingly. The shadow could be updated by repeating the method 300 of FIG. 3 for multiple intermediate positions of the virtual light source.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A physical computer program product comprising one or more physical computer-readable media having thereon one or more computer-executable instructions that, when executed by one or more processors of a computing system, causes the computing system to perform a method for displaying with shadows a plurality of visual items at a plurality of different virtual display levels, the method comprising:
an act of determining a position and a virtual display level for each of the plurality of visual items to be displayed on the display; and
for at least one of the plurality of visual items that casts a shadow that has a plurality of in-shadow visual items at lower virtual display levels than the shadow-casting visual item when the shadow-casting virtual item is in the position of the shadow-casting visual item determined in the act of determining, an act of using the determined position of the shadow-casting visual item to render the shadow on each of the plurality of in-shadow visual items differently depending on the corresponding virtual display level of each of the in-shadow visual items such that an in-shadow visual item that has a lower virtual display level has a longer shadow cast by the shadow-casting visual item, and an in-shadow visual items that has a higher virtual display level has a shorter shadow cast by the shadow-casting visual item.

2. The physical computer program product in accordance with claim 1, wherein the shadow-casting visual item is static at least during the act of rendering.

3. The physical computer program product in accordance with claim 1, wherein if the shadow-casting visual item is being moved, the act of determining the position and the act of rendering are performed at incremental positions of the shadow-casting visual item as the shadow-casting visual item is being moved.

4. The physical computer program product in accordance with claim 3, wherein as the shadow-casting visual item is being moved, the set of in-shadow virtual items changes, causing the act of rendering to consider the changed set of in-shadow virtual items for each subsequent act of rendering for each corresponding incremental position of the shadow-casting visual item.

5. The physical computer program product in accordance with claim 1, wherein the shadow-casting visual item is a first shadow-casting visual item, the shadow is a first shadow, and the plurality of in-shadow visual items is a first plurality of in-shadow visual items, the method further comprising the following for at least a second shadow-casting visual item of the plurality of visual items when the second shadow-casting virtual item is in the position of the second shadow-casting visual item determined in the act of determining,
act of using the determined position of the second shadow-casting visual item to render a second shadow on each of a second plurality of in-shadow visual items differently depending on the corresponding virtual display levels of the second plurality of in-shadow visual items such that an in-shadow visual item that has a lower virtual display level has a longer shadow cast by the second shadow-casting visual item, and an in-shadow visual items that has a higher virtual display level has a shorter shadow cast by the second shadow-casting visual item.

6. The computer program product in accordance with claim 5, wherein the second shadow-casting visual item is one of the first plurality of in-shadow visual items.

7. The computer program product in accordance with claim 1, wherein one of the plurality of in-shadow visual items is a background canvas, and another of the plurality of in-shadow visual items is at a virtual display level above the background canvas.

8. The computer program product in accordance with claim 1, wherein the act of using the determined position of the shadow-casting visual item to render the shadow further uses a position of a virtual light source to render the shadow.

9. The computer program product in accordance with claim 8, wherein the virtual light source may be moved to thereby causing the act of using the determined position of the shadow-casting visual item to render the shadow to be re-performed with respect to the new position of the virtual light source.

10. The computer program product in accordance with claim 8, wherein the virtual light source is a virtual point light source.

11. The computer program product in accordance with claim 8, wherein the virtual light source is a virtual area light source.

12. The computer program product in accordance with claim 8, wherein the virtual light source is a plurality of discrete virtual light sources.

13. The computer program product in accordance with claim 8, wherein the virtual light source may be made to move such that the shadow of the shadow-casting virtual item also moves.

14. The computer program product in accordance with claim 1, wherein at least a color of the shadow is configurable.

15. The computer program product in accordance with claim 1, wherein the shadow-casting visual item is at least partially translucent thereby allowing at least one of the plurality of in-shadow visual items to be at least partially visible though the shadow-casting visual item, and wherein the shadow cast by a corresponding piece of the shadow-casting visual item has a strength that is weaker due to a translucency level of the corresponding piece.

16. A method for rendering shadows of a plurality of visual items at a plurality of different virtual display levels on a display, the method comprising:
an act of determining a position and a virtual display level for each of the plurality of visual items to be displayed on the display, the plurality of visual items including a plurality of shadow-casting visual items that are to be rendered with a shadow;
for each of the shadow-casting visual items, performing the following:
an act of identifying one of more in-shadow visual items that would be within a shadow of the corresponding shadow-casting visual item given a virtual light source;
for each of the one or more in-shadow visual items, an act of formulating the shadow of the shadow-casting visual item on the in-shadow visual item in a manner that depends on a difference between a virtual display level of the shadow-casting visual item and a virtual display level of the in-shadow visual item.

17. The method in accordance with claim 16, wherein for each of shadow-casting visual items, if there are a plurality of in-shadow visual items, then the act of formulating the shadow causes a length of the shadow to have a positive correlation with the difference between the virtual display level of the shadow-casting visual item and the virtual display level of the in-shadow visual item.

18. A method for rendering shadows in a visual environment that includes a background that has the lowest virtual display level, and a plurality of higher shadow-casting virtual display levels, at least some of the plurality of higher shadow-casting virtual display levels each having one or more shadow-casting visual items, the method comprising:
an act of determining a position and a virtual display level for each of the plurality of shadow-casting visual items;
an act of iteratively performing the following for each virtual display level beginning at the background and then for increasingly higher shadow-casting virtual display levels until there are no more higher shadow-casting virtual display levels having one or more shadow-casting visual items:
an act of calculating a shadow that would be cast on any visual display items of the corresponding virtual display level by collectively all of the shadow-casting visual items that are at higher virtual display levels than the corresponding virtual display level, wherein the act of calculating considers a difference in the virtual display level of the shadow-casting visual item and the corresponding display level that the shadow is cast on when calculating how long to make the shadow on any visual display items of the corresponding virtual display level;
an act of at least virtually rendering the calculated shadow on an aggregated rendering that began with the background;
an act of masking any shadow-casting visual items from the next higher virtual display level on the aggregated rendering;
if there are even higher virtual display levels even higher than the next higher virtual display level that have one or more visual items, an act of repeating the act of iteratively performing with the next higher virtual display level becoming the corresponding virtual display level;
if there are no higher virtual display levels even higher than the next higher virtual display level that have one or more visual items, an act of ending the act iteratively performing.

19. The method in accordance with claim 18, wherein the virtual display levels each correspond to a z-order.

20. The method in accordance with claim 18, wherein there are at least two higher shadow-casting virtual display levels, and wherein at least one shadow casting visual item casts a shadow on multiple in-shadow visual items from multiple virtual display levels.
